(19) United States
(12) Patent Application Publication
(10) Pub. No.: US 2023/0072692 A1
(43) Pub. Date: Mar. 9, 2023

(54) METHOD FOR PROVIDING A VIRTUAL REALITY EXPERIENCE FOR AT LEAST ONE PASSENGER OF AN AMUSEMENT RIDE, AND AMUSEMENT RIDE

(71) Applicant: VR COASTER GMBH & CO. KG, Kaiserslautern (DE)

(72) Inventors: Dennis GORDT, Sexau (DE); Michael HEYSE, Mainz (DE)

(21) Appl. No.: 17/801,146

(22) PCT Filed: Nov. 18, 2020
(86) PCT No.: PCT/EP2020/082593

§ 371 Date: Aug. 19, 2022

(30) Foreign Application Priority Data
Feb. 21, 2020 (DE) 10 2020 104 658.8

(51) Int. Cl. A63G 31/16; A63G 31/00; G01S 5/10; G06T 11/00

(52) U.S. Cl. CPC A63G 31/16; A63G 31/007; G01S 5/10; G06T 11/00; A63G 21/18

(57) ABSTRACT

A method provides a virtual reality experience for at least one passenger of an amusement ride, in particular a water ride, with at least two spaced-apart and stationary UWB antennas. The at least one passenger is able to move in the ride and is provided with VR goggles and a UWB tag. The VR goggles can present the virtual reality experience in the field of vision of the at least one passenger. The method includes the steps:
establishing a wireless connection and transmitting at least one signal between the at least two stationary UWB antennas and the UWB tag;
calculating the position of the UWB tag based on the at least one received signal;
generating a virtual reality according to the calculated position;
reproducing the virtual reality experience through the VR goggles according to the calculated position and the viewing direction of the VR goggles.

The present invention relates to a method for providing a VR experience for at least one passenger of an amusement ride comprising the features of claim 1 and an amusement ride comprising the features of claim 14.

Different applications of VR goggles in water or on slides are known from prior art. For example, WO 2019 059 959 A1 describes a method for providing a virtual reality experience for a slide ride, in which a participant moves along a water surface. During the slide ride, data on the passenger's position is collected in sections using what are referred to as “beacons”, allowing the continuous movement and orientation of the passenger's VR goggles to be approximately estimated. “Beacons” are comparable to light barriers and work via a received signal strength. The closer the passenger is to the “beacons” or to a light barrier, the greater the signal strength. Depending on the signal strength, the position of the passenger's VR goggles can be determined.

A disadvantage of this prior art has been found to be that the technology known from WO 2019 059 959 A1 only enables position detection in sections. The position of the at least one passenger is calculated in the sections between the individual “beacons” or light barriers using complex iterative processes and can only be supplemented by data from complex simulations.

If the passenger abruptly changes their speed while riding in the amusement ride, the real ride and the virtual reality experience will become asynchronous, since the virtual reality experience or the determination of the passenger's position does not take place continuously, and therefore an exact position and orientation of the passenger cannot be determined while riding with the VR goggles. In particular when riding through chaotic movement sections such as vortex or effect elements in a small space, determining position by means of “beacons” is not possible at all and can therefore lead to passenger injuries and endanger the safe operation of the amusement ride. Imprecise position determination and a non-synchronized representation of the virtual reality experience also lead to discomfort or motion sickness (nausea) or to an unsatisfactory driving experience.

Another disadvantage when using “beacons” is the inaccuracy of approximately 1 m to 3 m, and that with increasing distance to the light barrier or the “beacon” the signal strength decreases significantly and leads to further inaccuracies.

Optical tracking of the VR goggles from prior art should also be mentioned, which is carried out, for example, by camera-based position detection or optical inside-out tracking. However, such methods have proved to be too imprecise and therefore unsuitable in a water environment on the optical elements and the changed refraction.

This is where the present invention begins.

The object of the present invention is to expediently improve the methods known from prior art for detecting the position of at least one passenger wearing VR goggles in an amusement ride, and an improved method for providing a virtual reality experience for at least one passenger of an amusement ride, by which the position of the VR goggles, and therefore the passenger, is continuously ascertained even in direct contact with water.

These objects are achieved by a method according to the invention comprising the features of claim 1 and an amusement ride comprising the features of claim 14.

Further advantageous embodiments of the present invention are specified in the dependent claims.

The method according to the invention comprising the features of claim 1 for providing a virtual reality experience for at least one passenger of an amusement ride, in particular a water ride, such as a water slide and/or a water pool, with at least two spaced-apart and stationary UWB antennas, wherein the at least one passenger can move in the amusement ride, preferably in—particularly preferably direct—contact with water, wherein the at least one passenger is provided with VR goggles and a UWB tag, and wherein the VR goggles in the field of vision of the at least one passenger can present the VR experience. In addition, when the method is carried out, the invention allows a wireless connection to be established between the at least two stationary UWB antennas and the UWB tag and for at least one signal to be transmitted between the at least two stationary UWB antennas and the UWB tag. In addition, the position of the UWB tag is calculated using the at least one received signal, wherein the representation of the virtual reality experience is generated according to the calculated position.

Here and in the following, in connection with this invention, direct water contact of a passenger is understood to mean that the passenger is in a humid environment in which the passenger is on or near the water, for example on a water slide, in a swimming pool, in a plunge pool, or in a lake but also in an environment in which, for example, the water hits the at least one passenger, preferably by technical means. The passenger can move in the amusement ride with a movement means, which can be, for example, an inflatable floating body, a swimming ring, a swimming mat or pad, a boat, a rolling and/or sliding body, or the like.

In addition, in the context of this invention, “UWB” can be understood as an ultra-wideband technology that can preferably use extremely large frequency ranges with a bandwidth of at least 500 MHz or at least 20% of the arithmetic mean of the lower and upper limit frequencies of the frequency band. The ultra-wideband technology enables precise position determination with an accuracy of approximately 10-30 cm.

In connection with this invention, VR goggles are understood to mean an HMD (head-mounted display) that is well known from prior art. The VR goggles can be an extended reality device and, with the help of computer programs, can present a simulated computer-generated environment or a pre-calculated panorama sequence according to the user's viewing direction, or can also generate an enhanced perception of sensory impressions within a multidimensional environment that can have a combination of real and virtual elements. Extended reality also comprises intermediate stages of virtuality, such as mixed reality (MR), augmented reality (AR), augmented virtuality (AV), and virtual reality (VR).

In the context of this invention, a UWB tag or a UWB antenna can be understood to mean an active transmitter and/or receiver that is set up to continuously transmit and/or receive an ultra-wideband signal.

According to a development of the present method, the position of the UWB tag can be calculated using the signals received from the at least two stationary UWB antennas. In this preferred refinement, the UWB tag, preferably as an active UWB tag, can continuously transmit the at least one signal which is received by the at least two UWB antennas.

In the event that two UWB antennas receive the UWB tag signal, a corrected position can be determined or a plausibility check can be carried out using a projection onto a plane or a track on which the passenger can move through the amusement ride. Freely determining the position of the UWB tag in three-dimensional space requires at least three UWB antennas.

In a further development of the present method, the position of the UWB tag is calculated using the signals transmitted by the at least two stationary UWB antennas. The position is calculated using the UWB tag moved by the at least one passenger or a movement means, which means that there is no need for a complex calculation by a stationary signal processing device. The UWB tag can be carried by the passenger, wherein the UWB tag can be arranged directly on the goggles, on the passenger, and/or on the movement means.

In an advantageous development of the present method, the calculated position is transmitted to the VR goggles and the VR goggles generate and present the virtual reality experience according to the calculated position and the viewing direction of the VR goggles. The position can be transmitted to the VR goggles via Bluetooth or WLAN. The VR goggles can have appropriate sensors that can be used to determine the viewing direction of the at least one passenger or the orientation of the VR goggles in the room and can also run a VR software application tailored to the amusement ride that produces a stereoscopic representation for the passenger.

In a preferred development of the method, the position of the UWB tag can be calculated at a rate of approximately 100 Hz, that is, a hundred times per second. Likewise, the calculated position can be transmitted to the VR goggles at a predetermined rate, wherein the position is preferably transmitted to the VR goggles at a rate of 100 Hz, that is, a hundred times per second.

According to a development, the virtual reality experience can be generated according to the calculated position, wherein the virtual reality environment can be transmitted to the VR goggles and the virtual reality experience according to the viewing direction of the VR goggles can be reproduced. In other words, the virtual reality experience can be streamed to the VR goggles, wherein it is possible to extract a representation of the virtual reality experience corresponding to the passenger's viewing direction from the VR goggles by masking the areas that are not to be represented. It is therefore not absolutely necessary for the virtual reality experience to be generated/calculated by a VR software application in the VR goggles; instead, corresponding content can be generated by a stationary computer or server and a VR software application and transmitted or streamed to the VR goggles. The VR goggles can also send the viewing direction for generating/calculating the virtual reality experience to the stationary computer or server. Transmission can take place via Bluetooth or WLAN.

According to a further advantageous embodiment, at least three UWB antennas are distributed on the amusement ride, wherein the at least three UWB antennas, in a preferred development, are arranged such that there is a continuous connection between the antennas and the UWB tag. Furthermore, a connection can be established between at least four, preferably five, more preferably six, even more preferably seven, and most preferably with the at least eight and more UWB antennas simultaneously. With more than three UWB antennas, a particularly precise calculation of the position of the UWB tag is possible. If the UWB antennas are positioned outside the track, two UWB antennas are sufficient, wherein the position can then however be determined only in two axes or dimensions, which, nevertheless, is sufficient for determining the exact position on the route of the track.

In a further embodiment of the present invention, the at least one signal is transmitted between the at least two UWB antennas and the UWB tag continuously or in short time pulses (10 ms, 50 ms, 100 ms, 100-500 ms). In particular, it is preferable for the at least UWB antennas and/or the UWB tag to be able to transmit and/or receive the at least one signal continuously or in short time pulses (10 ms, 50 ms, 100 ms, 100-500 ms), whereby several passengers can simultaneously use the amusement ride and experience the virtual reality experience independently of one another.

In a preferred development of the present invention, the position of the UWB tag is determined via triangulation and/or trilateration. While triangulation is based on determining a position over a number of angles, trilateration is based on displacement, distance, and/or signal propagation time measurements in order to determine the position. For example, at least three UWB antennas as position transmitters can transmit both their position and a unique time stamp at predetermined time intervals, whereby the position of the UWB tag can be continuously determined using the signals from the UWB antennas acting as position sensors.

In a further advantageous implementation of the method according to the invention, the UWB tag and the VR goggles are connected via an interface. The interface between the UWB tag and the VR goggles can be wireless or wired, and the UWB tag can also be powered by the power source of the VR goggles. In a preferred embodiment, the VR goggles and the UWB tag are arranged in a common, and preferably waterproof, housing and form an integral unit. The UWB tag can communicate with the VR goggles, for example, via Bluetooth or WLAN.

According to a further preferred development of the method according to the invention, the amusement ride has a track that is preferably flushed with water and/or a water basin, wherein it is possible for both the track and the water basin to be configured to accommodate the at least one passenger. The track that is preferably flushed with water can be either a flow channel known from the prior art, a rafting channel, or a water slide, down which the passenger can either slide freely or drive through. The track, through which water has preferably been flushed, can also be traversed by means of a movement means, for example a rubber tire, a boat, a buoyant body, or some other type of sliding or rolling body. The at least two UWB antennas are spatially distributed in the amusement ride and, in a preferred embodiment of the amusement ride and in a preferred embodiment of the method, can be arranged above the water-flushed track and/or above the water basin.

The UWB tag does not necessarily have to be permanently coupled with the VR goggles or the passenger for the method. The UWB tag can also be coupled with the movement means such as the rubber tire, the boat, the buoyant body, or the other type of sliding or rolling body so that the position of the

In addition, in a preferred development of the present method, the position of the UWB tag is calculated using the at least one signal and a correction is made using a previously stored data set that contains geometric information about the nature of the amusement ride. For example, to determine the exact and/or a corrected position of the UWB tag, previously stored data about the course of the track or the pool can be used, which are preferably stored as three-dimensional coordinates or mathematical functions.

According to the invention, not only is the position of the at least one passenger and/or the movement means in the amusement ride, for example, along the track, the slide, or the pool monitored, but the position of VR goggles of at least one passenger who, for example, dives or swims in a water pool.

In contrast to the systems known from prior art, the at least one passenger can swim or dive freely in the water pool and an artificial water world can be simulated and presented using the VR goggles. Possible obstacles, such as the edge of the water pool, can also be presented in the virtual world.

It is also possible to use the method according to the invention and the amusement ride according to the invention to increase safety. For example, by detecting the position of the at least one passenger, a minimum distance between multiple passengers in the amusement ride can be specified. For example, the amusement ride or the—preferably water-flushed—track can be released to start at a minimum distance, which also allows an increase in the frequency and throughput of the amusement ride. In knowledge of the position of a plurality of passengers, the respective other passengers can also be presented in the virtual representation of the at least one passenger, in order to avoid collisions, for example.

Another aspect of the present invention relates to an amusement ride with a track that is preferably flushed with water and/or a water pool and at least two stationary UWB antennas that are spaced apart from one another for carrying out the method according to the invention described above.

In addition, it has proved to be advantageous for the at least two UWB antennas to be connected to a signal processing device of the amusement ride, wherein the signal processing device is able to calculate the position of the UWB tag of the at least one passenger using the signals received from the at least two antennas and the signal processing device being able to transmit the calculated position to the VR goggles.

The position can be transmitted either indirectly via the UWB tag or directly to the VR goggles.

Furthermore, it has alternatively proved to be advantageous for the at least two UWB antennas to be connected to a signal processing device, wherein the signal processing device is able to calculate the position of the UWB tag of the at least one passenger based on the signals received from the at least two antennas, and the signal processing device generating the virtual reality experience based on the calculated position and transmitting or streaming said experience to the VR goggles. Based on the received VR content, the VR goggles can use a masking that corresponds to the current viewing direction of the passenger in order to extract the perspective corresponding to the viewing direction from the received VR content and to present the virtual reality experience to the passenger.

An embodiment of the ride according to the invention and the method according to the invention for providing a virtual reality experience for at least one passenger on an amusement ride are described in detail below with reference to the accompanying drawing.

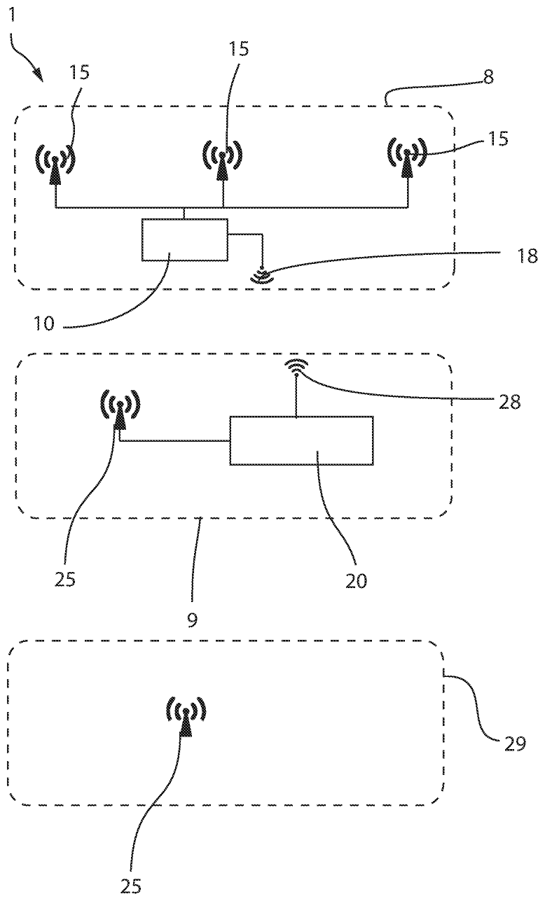

FIG. 1 shows a greatly simplified and schematic representation of the amusement ride 1 according to the invention. The amusement ride 1 can, for example, be a water ride such as a water slide, a swimming pool, a plunge pool, a water channel, and/or the like, wherein the ride can also have a course in which the passenger can come into contact with water in a targeted manner, for example by spraying it in a targeted manner.

In FIG. 1, the stationary components of the amusement ride 1 are identified by reference number 8 and the components that move with the at least one passenger (not shown) are identified by reference number 9. The amusement ride 1 enables a large number of passengers to experience the virtual reality experience at the same time. For example, a plurality of passengers can be in the water pool and experience the same virtual reality experience or one customized according to their preferences at the same time It is also possible for a plurality of passengers to slide down the water-flushed track or the water slide at the same time or one after the other.

The stationary components of the amusement ride 1 comprised a plurality of UWB antennas 15 (not shown in detail) which are spaced apart from one another and distributed in the amusement ride 1. The UWB antennas 15 are connected to a signal processing device 10, wherein the signal processing device 10 is able to evaluate the signals received from the UWB antennas 15. The signal processing device 10 also has a communication interface 18.

A passenger (not shown) can carry the components 9 with him in the amusement ride 1. These components 9 comprise VR goggles 20 (not shown in detail) and a preferably active UWB tag 25.

In addition, at least one movement means such as a swimming ring or boat—identified by reference number 29 in FIG. 1—can also be equipped with a preferably active UWB tag 25, so that these can be presented in the VR display independently of the passenger.

The VR goggles 20 can generate VR content from a program stored in a memory (not shown) and reproduce it via display means (not shown) in the current field of view, preferably by a stereographic representation. VR goggles 20 of this kind are well known from prior art and are often also referred to as an HMD (head-mounted display). The VR goggles 20 can be an extended reality device and, with the aid of computer programs, can generate an enhanced perception of sensory impressions within a multidimensional environment, which can comprise a combination of real and virtual elements. Extended reality also comprises intermediate stages of virtuality, such as mixed reality (MR), augmented reality (AR), augmented virtuality (AV), and virtual reality (VR).

The active UWB tag 25 can either be carried by the passenger, fastened to the VR goggles 20, or arranged on the movement aid that the passenger can carry with them. The UWB tag 25 can transmit an electrical signal that can be received by the UWB antennas 15. Typically, such a UWB tag 25 can transmit and/or receive an electrical signal.

The UWB tag 25 and/or the UWB antennas 15 work with a low transmission power of approx. 0.5 mW/41.3 dBm/MHz, which is why frequency ranges that have already been set are not disturbed.

The signals sent by the relevant UWB tag 25 can be received by the UWB antennas 15 and the signal processing device 10 can determine an exact position of the UWB tag 25 in the amusement ride 1 either via triangulation or trilateration. In a preferred embodiment, more than three UWB antennas are used, and a position can be calculated up to 100 times per second, as a result of which height differences in particular can be precisely determined.

The calculated position of the at least one UWB tag 25 can be transmitted via the communication interface 18 either to the UWB tag 25 via one of the UWB antennas 15 or directly to a communication interface 28 of the movable components 9 or the VR goggles 20. The communication interfaces 28, 18 can for example communicate via WLAN or Bluetooth.

Based on the calculated position, the VR goggles 20 can generate and present a stereo-geographic representation of a virtual reality corresponding to the current position by means of a VR software application together with a passenger's viewing direction determined by a corresponding sensor system.

### LIST OF REFERENCE SYMBOLS

1 Amusement ride
8 Stationary components
9 Moving components
10 Signal processing device
15 UWB antennas
18 Communication interface from 8
20 VR goggles
25 UWB tag
28 Communication interface from 9
29 Movement means

1. A method for providing a virtual reality experience for at least one passenger of an amusement ride (1), in particular a water ride, comprising at least two spaced-apart and stationary UWB antennas (15), wherein the at least one passenger is able move in the amusement ride (1), the at least one passenger being provided with VR goggles (20) and a UWB tag (25), and the VR goggles (20) being able to present the virtual reality experience in the field of vision of the at least one passenger, characterized by the method steps:
establishing a wireless connection and transmitting at least one signal between the at least two stationary UWB antennas (15) and the UWB tag (25);
calculating the position of the UWB tag (25) using the at least one received signal;
generating a virtual reality according to the calculated position;
reproducing the virtual reality experience through the VR goggles (20) according to the calculated position and the viewing direction of the VR goggles (20).

2. The method according to claim 1, characterized in that the position of the UWB tag (25) is calculated using the signals received from the at least two stationary UWB antennas (15).

3. The method according to claim 1, characterized in that the position of the UWB tag (25) is calculated using the signals transmitted by the at least two stationary UWB antennas (15).

4. The method according to claim 1, characterized in that the calculated position is transmitted to the VR goggles (20), and in that the VR goggles (20) produce and present the virtual reality experience according to the calculated position and the viewing direction of the VR goggles (20).

5. The method according to claim 1, characterized in that the virtual reality experience is generated according to the calculated position, and in that the virtual reality experience is transmitted to the VR goggles (20) and the virtual experience is reproduced according to on the viewing direction of the VR goggles (20).

6. The method according to claim 1, characterized in that at least three UWB antennas (15) are distributed on the amusement ride (1).

7. The method according to claim 1, characterized in that the at least one signal is transmitted continuously between the at least two stationary UWB antennas (15) and the UWB tag (25).

8. The method according to claim 1, characterized in that the position of the UWB tag (25) is calculated via triangulation and/or trilateration.

9. The method according to claim 1, characterized in that the UWB tag (25) is connected to the VR goggles (20) via an interface.

10. The method according to claim 1, characterized in that the UWB tag (25) is supplied with power via the power source of the VR goggles (20).

11. The method according to claim 1, characterized in that the UWB tag (25) communicates wirelessly or with a cable with the VR goggles (20).

12. The method according to claim 1, characterized in that the amusement ride (1) has a track and/or a pool that is preferably flushed with water, and in that the at least two UWB antennas (15) are arranged so as to be spatially distributed, preferably over the water-flushed track and/or the pool.

13. The method according to claim 12, characterized in that the position of the UWB tag (25) is calculated using the at least one received signal and the course of the track and/or the pool stored as a model.

14. An amusement ride (1) comprising a preferably water-flushed track and/or a pool and at least two stationary and spaced-apart UWB antennas (15) for carrying out a method according to claim 1.

15. The amusement ride (1) according to claim 14, characterized in that the at least two UWB antennas (15) are connected to a signal processing device (10), in that the signal processing device (10) can calculate the position of the UWB tag (25) of the at least one passenger based on the signals received from the at least two antennas (15), and in that the signal processing device (10) can transmit the calculated position to the VR goggles.

16. The amusement ride (1) according to claim 14, characterized in that the at least two UWB antennas (15) are connected to a signal processing device (10), in that the signal processing device (10) can calculate the position of the UWB tag (25) of the at least one passenger based on the signals received from the at least two antennas (15), and in that the signal processing device (10) generates the virtual reality experience based on the calculated position and can transmit or stream it to the VR goggles (20).
